(19) United States
(12) Patent Application Publication
(10) Pub. No.: US 2007/0174158 A1
(43) Pub. Date: Jul. 26, 2007

(54) Data processing system, RFID reader and data processing method

(76) Inventors: Antje Bredehoeft, Malsch (DE); Birgit Oettinger, Schwetzingen (DE); Till Oppert, Worms (DE)

Correspondence Address: SAP / FINNEGAN, HENDERSON LLP, 901 NEW YORK AVENUE, NW, WASHINGTON, DC, 20001-4413, US

(21) Appl. No.: 11/646,281

(22) Filed: Dec. 28, 2006

(30) Foreign Application Priority Data
Jan. 4, 2006 (EP) 06100091.5

(51) Int. Cl. G07F 19/00; G07B 17/00

(52) U.S. Cl. 705/30

(57) ABSTRACT

The present invention relates to a data processing system comprising a posting component for receiving a posting request. The posting request contains a process code being indicative of one of a plurality of business processes and at least one object identifier for identification of an object of the one business process. An accounting voucher generator component generates an electronic accounting voucher for documentation of a posting performed in response to the posting request and selects one of a plurality of posting schemes using the process code. Each of the plurality of posting schemes have posting positions having a predefined position type. A category identification component identifies a category of the posting using at least the object identifier. An account determination component determines an account identifier using the category and the position type. The posting component generates an account determination request containing the position type of the selected one of the posting schemes and the object identifier and the account determination component returns the account identifier in response to the account determination request for entry of the account identifier into the accounting voucher.

### BACKGROUND

I. Technical Field

The present invention relates to the field of data processing and, more particularly, without limitation to enterprise resource planning systems and radio frequency identification (RFID).

II. Background Information

The posting of posting items in an enterprise resource planning (ERP) system is typically documented by means of so-called accounting vouchers that are also referred to as book keeping vouchers or journal vouchers. The documentation of postings by means of accounting vouchers is regulated by law in several countries. For example, paragraph 257 of the German Commercial Code (HGB) requires such documentation. In general, the accounting documentation of the postings of a company needs to meet the applicable regulatory requirements. In particular, the documentation of the postings by means of accounting vouchers needs to be auditable.

In order to facilitate such documentation requirements, a variety of accounting voucher forms, including electronic accounting voucher forms, are used in prior art ERP systems, such as SAP's R/3 system.

Electronic accounting voucher forms can have various formats that enable manual data entry, such as a mark-up language formats, extended mark-up language formats, spreadsheet or editable PDF formats. In prior art ERP systems some degree of manual interaction is required for completion of an accounting voucher form especially regarding the determination and entry of an account number for the respective posting.

### SUMMARY

One aspect of the present disclosure is directed to a data processing system. The data processing system may include a posting component for receiving a posting request, the posting request containing a process code being indicative of one of a plurality of business processes and at least one object identifier for identification of an object of the one business process, and an accounting voucher generator component for generating an electronic accounting voucher for documentation of a posting performed in response to the posting request, the accounting voucher generator component being adapted to select one of a plurality of posting schemes using the process code, each of the plurality of posting schemes having posting positions, each posting position having a predefined position type. The data processing system may further include a category identification component for identification of a category of the posting using at least the object identifier, and an account determination component for determination of an account identifier using the category and the position type. The posting component may be adapted to generate an account determination request containing the position type of the selected one of the posting schemes and the object identifier and the account determination component being adapted to return the account identifier in response to the account determination request for entry of the account identifier into the accounting voucher.

The present disclosure may facilitate the automated performance of postings and the automatic generation of the required documentation, i.e., accounting vouchers, without a need for manual user interaction. In particular, the present disclosure may enable the automated determination of account identifiers, e.g., account numbers, for the postings and the respective accounting vouchers.

In accordance with an embodiment of the present disclosure, the posting component may receive the posting request from a client computer. The posting request may be entered automatically or manually into the client computer.

In accordance with an embodiment of the present disclosure, the posting component may alternatively or additionally receive the posting request from a radio frequency identification (RFID) reader. Receiving the posting request from a RFID reader may eliminate a need for a manual entry of the posting request. Rather, data that is required for generating the posting request may be entered automatically using a RFID transponder, and the posting request may then be generated automatically by the RFID reader after receiving certain information from the RFID transponder.

In accordance with an embodiment of the present disclosure, the data processing system may include a user interface that facilitates the entry of account determination logic parameters. Preferably, the user interface may include a data entry table for tabular entry of account identification parameters such as, for example, account identifiers.

Another aspect of the present disclosure is directed to a data processing method. The data processing method may include receiving a posting request, the posting request containing a process code being indicative of one of a plurality of business processes and at least one object identifier for identification of an object of the one business process, and selecting one of a plurality of posting schemes using the process code, each of the plurality of posting schemes having posting positions, each posting position having a predefined position type. The data processing method may further include generating an electronic accounting voucher for documentation of the posting performed in response to the posting request by instantiation of the selected posting scheme, identification of a category using at least the object identifier, determining an account identifier using the category and the position type of the instantiated posting scheme, and automatic entry of the account identifier into the accounting voucher. The data processing method may be performed, at least in part, by a computer program product including computer executable instructions for performing the data processing method.

Still another aspect of the present disclosure is directed to a RFID reader for generating posting requests for processing of the data processing system of the invention. The RFID reader may preferably include a non-volatile memory for permanent storage of a process code that corresponds to a physical location and use of the RFID reader in a respective business process. For example, the RFID reader may be located in a goods receiving department. The RFID reader may store a corresponding process code, i.e. a process code identifying a process for receiving of goods.

It is to be understood that both the foregoing general description and the following detailed description are exemplary and explanatory only and are not restrictive of the invention or embodiments thereof, as claimed.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 is a block diagram illustration of an exemplary disclosed data processing system;

FIG. 2 is a flowchart illustrating an exemplary disclosed data processing method;

FIG. 3 is a schematic illustration of an exemplary disclosed electronic accounting voucher;

FIG. 4 is a block diagram illustration of an exemplary disclosed RFID reader; and

FIG. 5 is a diagrammatic illustration of an exemplary disclosed user interface.

### DESCRIPTION OF THE EMBODIMENTS

The following detailed description refers to the accompanying drawings. Wherever possible, the same reference numbers are used in the drawings and the following description to refer to the same or similar parts. While several exemplary embodiments and features of the invention are described herein, modifications, adaptations and other implementations are possible, without departing from the spirit and scope of the invention. For example, substitutions, additions or modifications may be made to the components illustrated in the drawings, and the exemplary methods described herein may be modified by substituting, reordering, or adding steps to the disclosed methods. Accordingly, the following detailed description does not limit the invention. Instead, the proper scope of the invention is defined by the appended claims.

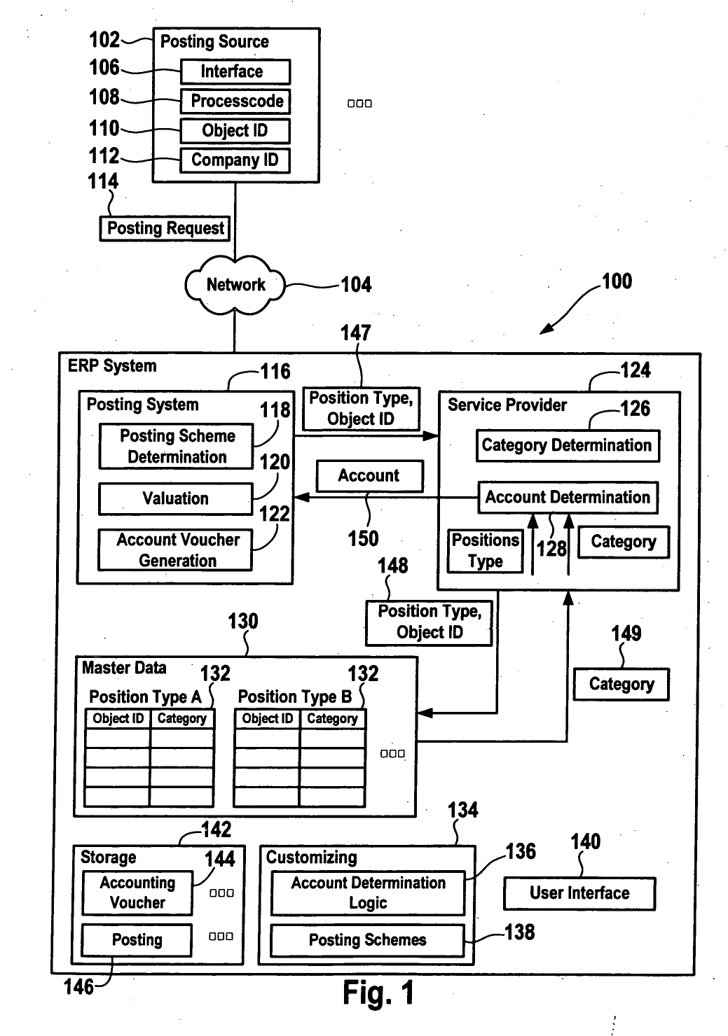

FIG. 1 illustrates a data processing system 100, such as an enterprise resource planning (ERP) system. Data processing system 100 may be coupled with at least one posting source 102 by means of a network 104. Posting source 102 may form an integral part of the ERP system. Network 104 may embody a company's intranet, an extranet or the Internet.

Posting source 102 may include an interface 106 for receiving posting data by manual input and/or automatically. Posting source 102 may further include one or more memory components for storing a process code 108, an object identifier (ID) 110, a company identifier (ID) 112, and/or other process data to be posted which will be referred to in the following as posting data. Depending on the implementation of interface 106, the posting data may be entered manually or at least partially by one or more automated electronic communications. Some of the posting data may be predefined. Predefined posting data may be permanently stored in posting source 102.

In response to entry of posting data via interface 106, posting source 102 may generate a posting request 114 that is sent from posting source 102 via network 104 to data processing system 100. Posting request 114 may include the posting data, e.g., process code 108, object ID 110, and company ID 112.

Data processing system 100 may include a posting system 116 for processing of posting request 114 and other posting requests received from posting source 102 or other posting sources coupled with data processing system 100. Posting system 116 may include a program component 118 for determination of a posting scheme, which may facilitate performance of a posting request that has been received via network 104, a program component 120 for valuation of a posting item contained in the posting scheme and/or posting request 114, and a program component 122 for generating an electronic accounting voucher for documentation of the posting.

Data processing system 100 may further include a component that implements a service provider 124 for automatic determination of account identifiers for posting system 116. Service provider 124 may include a program component 126 for determining a posting category, and a program component 128 for determining an account identifier for the posting by means of the posting category and a position type. The posting category may also be referred to as account determination Group. A plurality of posting categories may be predefined and may constitute abstractions of similar types of postings. A level of granularity of the posting category definitions may be adapted to the needs and internal procedures of a company that runs data processing system 100. Each posting category may serve to categorize objects associated with a posting, e.g., domestic or foreign customers, machines or real estate.

Data processing system 100 may also include master data 130. Master data 130 may include a table 132 for each position type of the posting schemes that are defined in data processing system 100. For example, table 132 for a position type A may assign a category to each object of position type A. Similarly, table 132 for a position type B may assign a category to each object ID of that position type B. However, one skilled in the art will appreciate that the categorization of master data may not depend on the position types. For example, tables 132 for “position type A” and “position type B” may be represented as tables 132 for “master data A” and “master data B”, respectively.

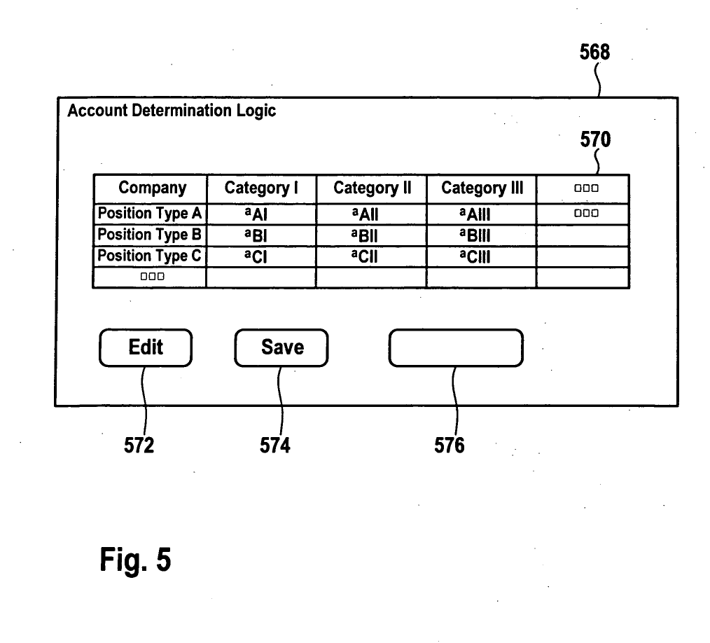

Further, the data processing system 100 may include a customizing unit 134 for storage of customizing parameters 136 that determine an account determination logic and store a plurality of predefined posting schemes 138 of data processing system 100. A user interface 140 may facilitate for entry of customizing data, particularly customizing parameters 136, as will be explained in more detail below with reference to FIG. 5.

Also, data processing system 100 may include a storage 142 for storing an accounting voucher 144 and a respective posting 146.

In an exemplary operation of data processing system 100, posting data may be entered into posting source 102 via interface 106. In response, posting source 102 may generate posting request 114, which may be sent to data processing system 100 via network 104. Receipt of posting request 114 by data processing system 100 may invoke the program component 118.

Program component 118 may select one of predefined posting schemes 138 for execution of posting request 114. The selection of one of posting schemes 138 may be performed based on process code 108 that may have been received with posting request 114. For example, process code 108 may determine selection of one of posting schemes 138 by program component 118.

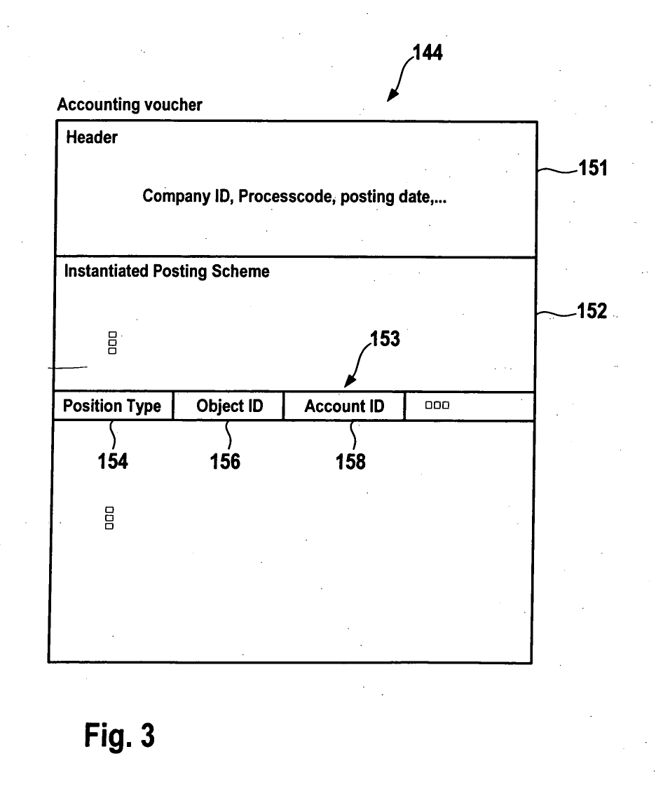

Further, program component 120 may be invoked in order to perform a valuation of the object identified by object identifier 110 in posting request 114, if necessary. Program component 122 may generate accounting voucher 144 by generating a header for accounting voucher 144 and by instantiating the selected posting scheme. An exemplary structure of accounting voucher 144 will be explained in greater detail below with reference to FIG. 3.

To determine an account identifier required for execution of posting request 114, posting system 116 may generate a request 147 that may be sent from posting system 116 to service provider 124. Request 147 may contain at least the position type of the instantiated posting scheme and the respective object ID of that position.

Receipt of request 147 by service provider 124 may invoke program component 126. Program component 126 may generate a query 148 in order to query master data 130 for determination of the category that is assigned to a tuple consisting of the position type and the object ID of request 147. However, it is contemplated that the account determination group may be assigned only to a single master data item rather than to a combination of position type and master data.

The position type indicated in query 148 may serve for selection of one of tables 132 whereas the object ID may serve as a key for access to the assigned category within the selected table 132. Alternatively, only the object ID may be used as a key.

As a result of query 148, a response 149 containing an indication of a category may be returned to service provider 124.

Service provider 124 may then enter the position type given in request 147 and the category received with response 149 into program component 128 for determination of an account identifier. Program component 128 may use customizing parameters 136 for determination of the account identifier. Program component 128 may generate a response 150, which may contain the account identifier.

Upon receipt of response 150 by posting system 116, the account identifier may be entered into accounting voucher 144. Further, a result of the valuation performed by program component 120, if any, may also be entered into accounting voucher 144. A value of the object may also be communicated to data processing system 100 as part of posting request 114. As a result of the execution of posting request 114, a respective posting 146 and associated accounting voucher 144 may be stored in the storage 142.

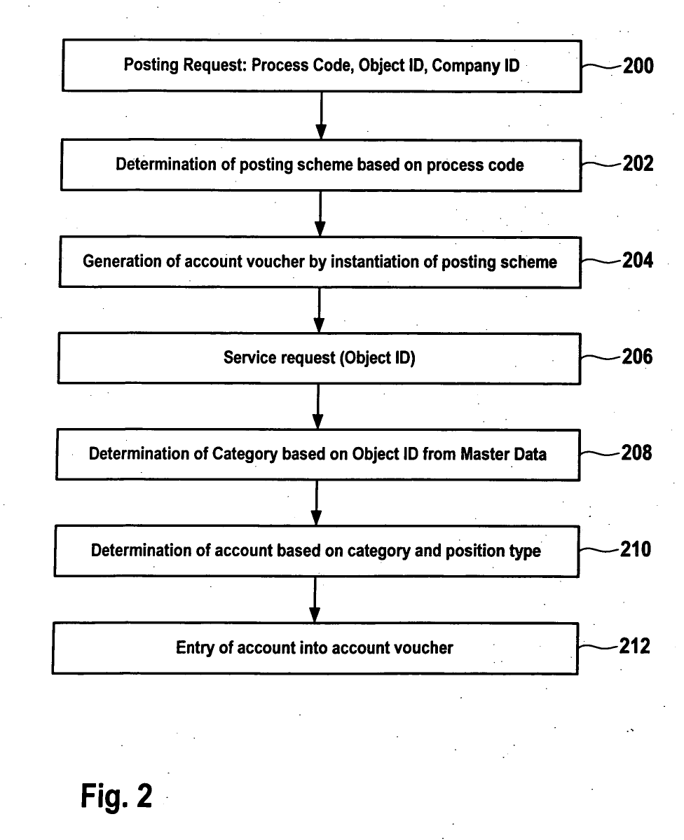

FIG. 2 illustrates a respective flowchart of the above-described method embodiment. In a Step 200, a posting request may be received from a posting source. For example, the posting request may carry a process code, an object ID, and a company ID. The process code may identify a business processes that may be defined for a company identified by the company ID. The object ID may define an object that may be related to the performance of the business process. Depending on the kind of business process identified, the object ID may identify a person such as, for example, an employee, a customer, or a business partner, an organizational entity such as, for example, a client company or cooperation, or a physical object such as, for example, a part, raw material, inventory item, or any other physical object.

The company ID may be required to identify a company of a corporation for which data processing system may be operated, such as an affiliated company, or a company in a corporate group or group of companies for which the positing request may be executed. If the data processing system is operated for, for example, a small or mid-sized single company the company ID may be obsolete.

In step 202, a posting scheme may be determined. For example, a posting scheme may be selected from a set of predefined posting schemes using the process code as a selection criterion. In one implementation, each of the predefined posting schemes may have an assigned process code. Hence, the process code that may be received with the posting request may determine the posting scheme to be used for processing of the posting request.

In step 204, an electronic accounting voucher may be generated for documentation of the requested posting. This may be done by generating lines of the account voucher. The accounting voucher may include a header for carrying header data such as, for example, the date the posting request was generated and the process code. The body of the accounting voucher may be obtained by instantiating the selected posting scheme.

To determine an account identifier for a position of the instantiated posting scheme, a service request may be generated that includes at least the object identifier of that position (Step 206). Preferably, the service request may also carry an indication of the position type of the respective position. Position type may be defined as a compulsory data item, and may optionally include master data.

A service provider may receive the service request and determine a posting category using parameters received with the service request (Step 208). For example, the posting category may be obtained by querying the master data using the object identifier.

In step 210, an account identifier may be determined using the posting category obtained in step 208 and the position type information. For example, the posting category and position type information may be evaluated by formulas or another evaluation logic in order to determine the account identifier belonging to that combination of category and position type.

In step 212, the account identifier may be returned to the posting system for entry into the accounting voucher. The completed accounting voucher may then be persistently stored for documentation purposes, and the requested posting may be executed using the account identifier.

FIG. 3 schematically illustrates a structure of an exemplary embodiment of accounting voucher 144. Accounting voucher 144 may include a header 151 having header data, such as the company ID, process code, the posting date, etc. A body 152 of accounting voucher 144 may be constituted by the selected instantiated posting scheme and may contain posting lines. FIG. 3 illustrates a posting position 153 contained in the instantiated posting scheme. One skilled in the art will appreciate that any instantiated posting scheme may include a plurality of posting positions.

Posting position 153 may include, for example, a field 154 for indicating the position type of posting position 153, a field 156 for indicating the object ID to which posting position 153 is related, and a field 158 for indicating an account identifier of an account on which the posting has been booked. Posting position 153 may additionally include such data as the positing amount as provided by the valuation program component (e.g., program component 120), with the posting request, and/or with other posting data. Other posting positions that may be included in body 152 may be of the same or a similar structure.

When accounting voucher 144 is initially generated such as by program component 122, the account identifier may be unknown to the posting system. The posting system may therefore request the account identifier from the respective service provider (cf. service provider 124). After receipt of the accounting identifier by the posting system from the service provider, the account identifier may then be entered into field 158 for completion of the accounting voucher and execution of the requested posting operation. As a result, the posting source may not need to deliver an account identifier together with the posting request. Rather, the account identifier may be obtained automatically by the posting system using the service provider.

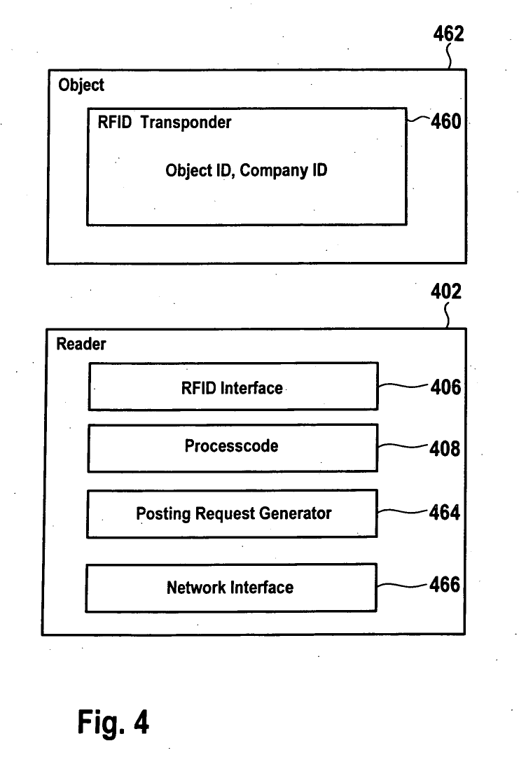

FIG. 4 illustrates an embodiment of a posting source using RFID technology. Elements in the embodiment of FIG. 4 that correspond to elements of the embodiment of FIG. 1 are designated by like reference numerals.

In the embodiment of FIG. 4, the posting source may be constituted by an RFID reader 402. RFID reader 402 may include an RFID interface 406 for radio frequency communication with an RFID transponder 460 of an object 462. By means of RFID interface 406, RFID reader 402 may read data that is stored in RFID transponder 460, such as an object ID of object 462 and a company ID.

RFID reader 402 may also include a non-volatile memory for storing a process code 408. For example, RFID reader 402 may be located at a delivery point where raw materials or parts, such as object 462, are delivered. Hence, process code 408 may identify ‘deliveries’ as the respective business process, as this may be the only business process in which RFID reader 402 is involved.

RFID reader 402 may further include a posting request generator 464 for generating posting requests in response to data that may have been read from RFID transponder 406. Additionally, RFID reader 402 may include a network interface 466 for sending the posting request to an enterprise resource planning system, such as data processing system 100.

Usage of RFID technology for implementation of the posting source may have the advantage that no manual interaction may be required for entering the posting data and initiating the posting request.

FIG. 5 illustrates an embodiment of user interface 140 for entry of account determination logic parameters. User interface 140 may generate a data entry window 568 containing a data entry table 570. Data entry table 570 may be company-specific such that a separate data entry table 570 may be provided for each of the companies of the corporation for which data processing system 100 is operated.

It is contemplated that rules used for account determination, defining which characteristics can be used for determination of the correct account, may be configured for each position type. Based on the these defined rules, the tables on user interface 140 may appear different from the illustrated data entry table 570 and/or each other.

In the exemplary embodiment of FIG. 5, a 2-tuple consisting of a category and a position type may determine an assigned account identifier. For assignment of the account identifiers, data entry table 570 may include columns corresponding to the various categories, i.e. category I, II, III,... and rows corresponding to the various position types, i.e. position type A, B, C,. . . .

For example, the following posting categories and position types are illustrated in the data entry table 570: category I=raw material; category II=merchandise; category III=finished product;. . . position type A=inventory; position type B=work in progress; position type C=. . . .

For assignment of an account identifier through the combination of a category and a position type, that account identifier may be entered into the field of the data entry table 570 whose column is given by the category and whose row is given by the position type. For example, the account identifier a_{Al} may be assigned to the 2-tuple consisting of position type A and category I, etc.

Other examples for posting categories (Account Determination Groups) may include: Material Account Determination Group, which may group materials for the purpose of account determination, and may include possible values such as: raw material, and merchandise material; and Business Partner Account Determination Group, which may group business partners for the purpose of account determination, and may include possible values such as: domestic business partner, and foreign business partner.

Other examples may include:
Concessions, Licenses and similar Rights; Real Estate; Buildings; Technical Assets and Machinery; Other Machinery, Furniture and Office Equipment; and AuC and Down Payments made as posting categories and Asset Portfolio as position types;
Posting categories as above and position types revenue from post-capitalization; gain from asset sale; loss from asset sale; and loss made on asset retirement w/o revenue scrapping as position types; and
Raw materials; supplies; semi finished products; finished products as posting categories and warehouse; and work in process as posting types.

Data entry window 568 may include a virtual control button 572 and a virtual control button 574. Further, data entry window 568 may include a data entry field 576 for entry of a company ID. The data entry table 570 may be opened and rendered on data entry window 568 in response to entry of the company ID in data entry field 576. To edit the data entry table 570, a user may click on control button 572. This may enable the user to enter or modify assignments of account identifiers to category/position type tuples. By clicking control button 574, a user may save assignments of account identifiers to category/position type tuples.

It is contemplated that data processing system 100 (cf. FIG. 1) may store charts of accounts that may be used for the determination of accounts for the performance of postings. For example, each company of a holding company that runs the data processing system 100 may have at least one such chart of accounts. Typically, each company may have two charts of accounts: one for the consolidated financial statement of the holding company, and one for the purposes of the company's financial statement.

The charts of accounts may be customizable. However, it is preferred that the data processing system 100 may be delivered with a default set of charts of accounts such that it can be used productively without delay.

The foregoing description has been presented for purposes of illustration. It is not exhaustive and does not limit the invention to the precise forms or embodiments disclosed herein. Modifications and adaptations of the invention will be apparent to those skilled in the art from consideration of the specification and practice of the disclosed embodiments of the invention. Further, computer programs based on the present discloure and methods consistent with the present invention are within the skill of an experienced developer. The various programs or program modules can be created using any of the techniques known to one skilled in the art or can be designed in connection with existing software. For example, program sections or program modules can be designed in or by means of Java, C++, HTML, XML, or HTML with included Java applets. One or more of such software sections or modules can be integrated into a computer system or existing e-mail or browser software.

Moreover, while illustrative embodiments of the invention have been described herein, the scope of the invention includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. Further, the steps of the disclosed methods may be modified in any manner, including by reordering steps and/or inserting or deleting steps, without departing from the principles of the invention. It is intended, therefore, that the specification and examples be considered as exemplary only, with a true scope and spirit of the invention being indicated by the following claims and their full scope of equivalents.

What is claimed is:

1. A data processing system comprising:
a posting component for receiving a posting request, the posting request containing a process code being indicative of one of a plurality of business processes and at least one object identifier for identification of an object of the one business process;
an accounting voucher generator component for generating an electronic accounting voucher for documentation of a posting performed in response to the posting request, the accounting voucher generator component being adapted to select one of a plurality of posting schemes using the process code, each of the plurality of posting schemes having posting positions, each posting position having a predefined position type;
a category identification component for identification of a category of the posting using at least the object identifier; and
an account determination component for determination of an account identifier using the category and the position type,
wherein the posting component is adapted to generate an account determination request containing the position type of the selected one of the posting schemes and the object identifier and the account determination component is adapted to return the account identifier in response to the account determination request for entry of the account identifier into the accounting voucher.

2. The data processing system of claim 1, wherein the posting component is adapted to receive the posting request from a radio frequency identification (RFID) reader.

3. The data processing system of claim 2, wherein the radio frequency identification (RFID) reader is adapted to generate the posting request.

4. The data processing system of claim 3, wherein the radio frequency identification reader permanently stores therein the process code.

5. The data processing system of claim 1, wherein the category identification component uses the position type for identification of the category.

6. The data processing system of claim 1, wherein the category of an object is stored as master data.

7. The data processing system of claim 1, further comprising a user interface for entering account determination logic parameters.

8. The data processing system of claim 7, wherein the user interface is adapted to display a table for a user's entry of account identifiers on table coordinates and a first table coordinate is given by a position type and a second table coordinate is given by a category.

9. A data processing method comprising:
receiving a posting request, the posting request containing a process code being indicative of one of a plurality of business processes and at least one object identifier for identification of an object of the one business process;
selecting one of a plurality of posting schemes using the process code, each of the plurality of posting schemes having posting positions, each posting position having a predefined position type;
generating an electronic accounting voucher for documentation of the posting performed in response to the posting request by instantiation of the selected posting scheme;
identifying a category using at least the object identifier;
determining an account identifier using the category and the position type of the instantiated posting scheme; and
automatically entering the account identifier into the accounting voucher.

10. The data processing system method of claim 9, wherein the posting request is received from a client computer.

11. The data processing method of claim 9, wherein the posting request is received from a radio frequency identification (RFID) reader.

12. The data processing method of claim 9, wherein the category is identified using the position type.

13. The data processing method of claim 9, further comprising entering account determination logic parameters via a user interface.

14. The data processing method of claim 13, wherein the account determination logic parameters comprises position type and category tuples, and each tuple has an assigned account identifier.

15. The data processing method of claim 14, wherein the assignment of account identifiers to tuples is performed by entry into a table.

16. A computer program product comprising computer executable instructions for performing the method of claim 9.

17. A radio frequency identification (RFID) reader comprising:
means for receiving at least an object identifier from an RFID transponder;
means for storing a process code, the process code being indicative of a predefined business process;
means for generating a posting request, the posting request comprising at least the process code and the object identifier; and
an interface for sending the posting request to a data processing system.
